(19) United States
(12) Patent Application Publication
(10) Pub. No.: US 2022/0290482 A1
(43) Pub. Date: Sep. 15, 2022

(54) SPLIT-AXIS POWER STRUT

(71) Applicant: Hi-Lex Controls, Inc., Rochester Hills, MI (US)

(72) Inventors: John Heiberger, Grand Blanc, MI (US); Ryan Bellaver, Rochester Hills, MI (US); Steve Brinck, Rochester Hills, MI (US)

(73) Assignee: Hi-Lex Controls, Inc.

(21) Appl. No.: 17/197,608

(22) Filed: Mar. 10, 2021

(51) Int. Cl. E05F 15/622; F16H 25/20

(52) U.S. Cl. CPC E05F 15/622; F16H 25/20; E05Y 2201/434; E05Y 2201/70; E05Y 2201/702; E05Y 2201/71; E05Y 2900/546

(57) ABSTRACT

A power strut assembly for raising and lowering a panel of an automotive vehicle includes a strut housing defining two parallel axes, i.e. a motor rotary axis and a spindle rotary axis. A drive motor disposed in the strut housing has an output shaft rotatable by the drive motor about the motor rotary axis. A drive spindle with a threaded section at least partially disposed in the strut housing is rotatable about the spindle rotary axis to move a spindle nut on the threaded section of the drive spindle. A motor-spindle transmission for transmitting a rotation of the output shaft to the drive spindle includes a motor wheel secured to the output shaft and a spindle wheel rigidly coupled to the drive spindle. The motor wheel and the spindle wheel extend in a common plane of rotation.

### TECHNICAL FIELD

The present disclosure relates to a power strut assembly for raising and lowering a panel of an automotive vehicle.

### BACKGROUND

In pickup trucks, the cargo area is accessible from the rear of the vehicle via a tailgate that can be lowered for access and raised for securing the load. It has become customary to motorize the tailgate so that raising and lowering the tailgate involves merely the push of a button.

Existing power tailgate drive units rely on access to the hinge or to a special linkage to drive the tailgate resulting in required body panel modifications or excessive packaging space internal to the body, which results in an increase in weight and cost while causing a decrease in structural integrity.

### SUMMARY

It is therefore desirable to provide a power strut assembly that is suitable for actuating a tailgate with a reduced packaging space requirement.

According to the present disclosure, a power strut assembly for raising and lowering a panel of an automotive vehicle comprises a strut housing defining two parallel axes, one of which is a motor rotary axis and the other one of which is a spindle rotary axis. A drive motor disposed in the strut housing has an output shaft rotatable by the drive motor about the motor rotary axis. A drive spindle with a threaded section at least partially disposed in the strut housing is rotatable about the spindle rotary axis parallel to the motor rotary axis. A spindle nut is arranged on the threaded section of the drive spindle. A motor-spindle transmission for transmitting a rotation of the output shaft to the drive spindle includes a motor wheel secured to the output shaft and configured to be rotated by the drive motor about the motor rotary axis and a spindle wheel rigidly coupled to the drive spindle and configured to rotate about the spindle rotary axis. The motor wheel and the spindle wheel extend in a common plane of rotation.

The motor wheel may be a motor gear and the spindle wheel may be a spindle gear, wherein the motor gear and the spindle gear have toothed profiles that mesh with each other. The motor gear and the spindle gear may be spur gears. Alternatively, the motor gear and the spindle gear may be helical gears for enhancing the torque transmission.

The motor wheel and the spindle wheel may alternatively be coupled via a drive belt.

A nut tube may be affixed to the spindle nut and have a free end extending outward from the strut housing beyond the drive spindle with an end plug shaped as a movable attachment element for attachment to a movable vehicle part.

Optionally, a compression spring surrounding the nut tube may axially bias the nut tube in a direction away from the spindle gear.

In one example, the motor wheel and the spindle wheel have identical diameters. For transmitting a greater torque at a lower speed, the motor wheel may have a smaller diameter than the spindle wheel.

For accommodating the motor wheel and the spindle wheel, the strut housing may have a first end cap defining a transmission space. The first end cap may have an axial protrusion shaped as a stationary attachment element for attachment to a stationary vehicle part.

At an opposite, second end of the strut housing, a second end cap may have a cable opening, through which a cable bundle connected to the drive motor extends out of the strut housing. The cable opening may be fitted with a flexible gasket guiding and protecting the cable bundle. The second end cap may have a further opening, through which a nut tube affixed to the spindle nut extends out of the strut housing.

The strut housing may form a spindle tube and a motor tube and optionally be reinforced by stiffening ribs extending between the motor tube and the spindle tube.

A motor bearing coaxial with the motor rotary axis may be mounted in the strut housing between the drive motor and the motor wheel, and a spindle bearing coaxial with the spindle rotary axis may be mounted in the strut housing between the threaded section of the drive spindle and the spindle wheel.

The drive motor may be contained in a motor housing fixedly held in the strut housing, wherein the motor housing further holds a reduction gear arrangement.

further details and benefits will become apparent from the following description of three examples by way of the appended drawings. The drawings are provided for purely illustrative purposes and are not intended to limit the scope of the present invention.

### BRIEF DESCRIPTION OF THE DRAWINGS

In the drawings,

FIG. 1 shows a perspective view of a first example of a power strut assembly according to the present disclosure;

FIG. 2 shows a partially cut-open view of the power strut assembly of FIG. 1;

FIG. 3 shows the power strut assembly of FIG. 1 without the strut housing;

FIG. 4 shows the power strut assembly of FIG. 1 without the strut housing and without the slide tube;

FIG. 5 shows a partial view of a second example of a power strut assembly according to the present disclosure with a belt drive;

FIG. 6. shows a partially cut-open view of a third example of a power strut assembly according to the present disclosure;

FIG. 7 shows the power strut assembly of FIG. 6 with all parts surrounding the nut tube removed;

FIG. 8 shows the power strut assembly of FIG. 7 with a slide tube surrounding the spindle nut; and

FIG. 9 shows the power strut assembly of FIG. 8 with a compression spring and an outer tube.

### DETAILED DESCRIPTION

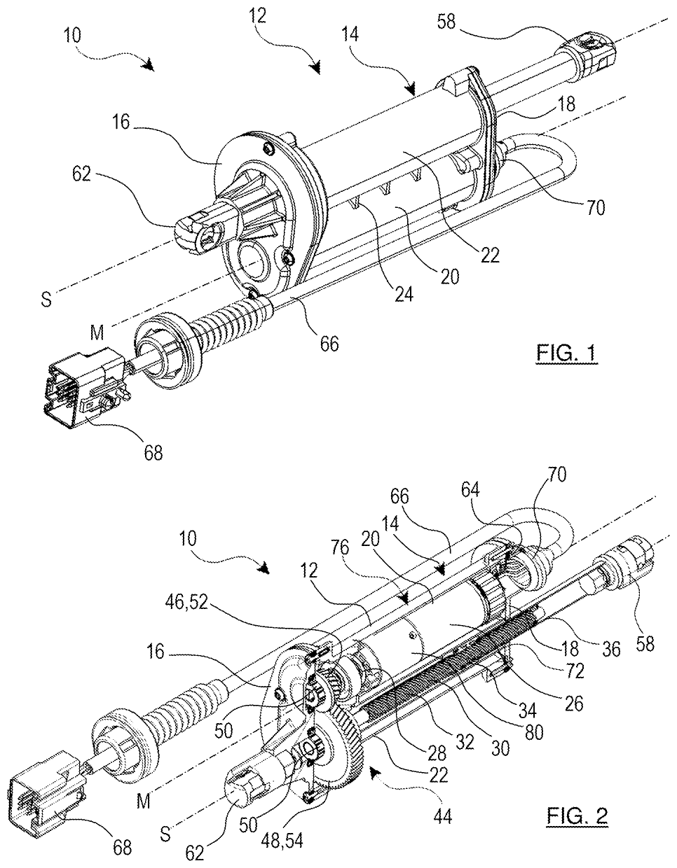

Referring to FIGS. 1-4, a first example of a power strut assembly 10 for performing a linear expansion and retraction for raising and lowering a panel of an automotive vehicle is shown. The power strut assembly 10 is shown in an assembled state, ready for installation. The power strut assembly 10 includes a strut housing 12 defining two parallel axes M and S, one of which is a motor rotary axis M and the other one of which is a spindle rotary axis S. The term “housing” is used here in a broad sense and relates to any structure that defines the parallel rotary axes M and S and the relative positions of individual parts of the power strut assembly 10 with respect to each other. Thus, while the strut housing 12 may enclose a volume, it may alternatively be realized as a frame or a bracket. In the example of FIGS. 1-4, the strut housing 12 is composed of a housing body 14, a first end cap 16, and a second end cap 18. The housing body 14 has two tubular volumes 20 and 22, one of which forms a motor tube 20, and the other one a spindle tube 22. The strut housing 12 further includes stiffening ribs 24 extending between the motor tube 20 and the spindle tube 22. Thus, the housing body 14 as shown is a single molded piece with two chambers that form the motor tube 20 and the spindle tube 22.

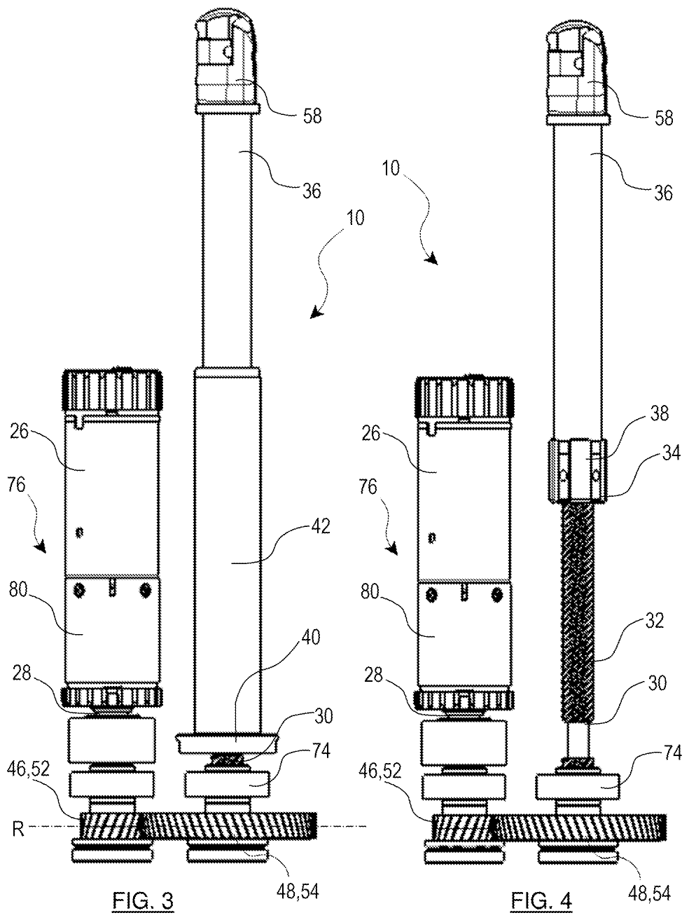

As best seen in FIG. 2, a drive motor 26 is disposed in the strut housing 12. The drive motor 26 has an output shaft 28 rotatable by the drive motor 26 about the motor rotary axis M. A drive spindle 30 with a threaded section 32 is at least partially disposed in the spindle tube 22 of the housing body 14. The drive spindle 30 is held in the strut housing 12 to be rotatable about the spindle rotary axis S, parallel to the motor rotary axis M. A spindle nut 34 is arranged on the threaded section 32 of the drive spindle 30 and is configured to travel along the threaded section 32 of the drive spindle 30 when the drive spindle 30 rotates. The spindle nut 34 is affixed to a nut tube 36 extending out of the housing through the second end cap 18. As shown I FIG. 4, the nut tube 36 or the spindle nut 34 has an anti-rotation profile 38 that is guided in a complementary profile in the inside of an outer tube 42 as shown in FIG. 3. The outer tube 42 is secured against rotation relative to the housing by an anti-rotation disc 40 shown in FIG. 3.

A motor-spindle transmission 44 is arranged at the housing end covered by the first end cap 16 that defines a transmission space. The motor-spindle transmission 44 transmits a rotation of the output shaft 28 to the drive spindle 30 and includes a motor wheel 46 secured to the output shaft 28 and configured to be rotated by the drive motor 26 about the motor rotary axis M. A spindle wheel 48 is rigidly coupled to the drive spindle 30 and configured to rotate about the spindle rotary axis S. As shown in FIG. 2, the motor wheel 46 and the spindle wheel 48 are keyed onto the output shaft 28 and the drive spindle 30, respectively. The shown example shows splined connections 50, but other mating shapes preventing relative rotation are well within the scope of the present invention.

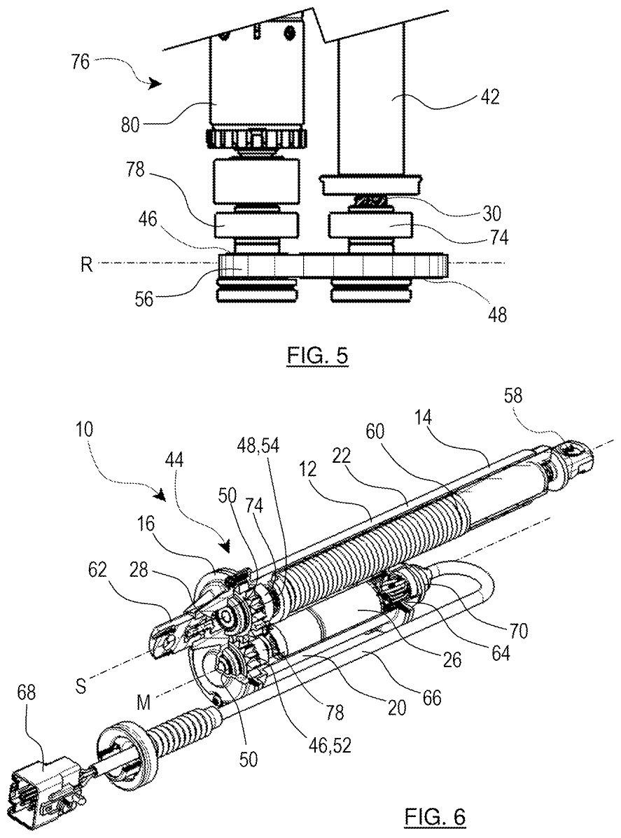

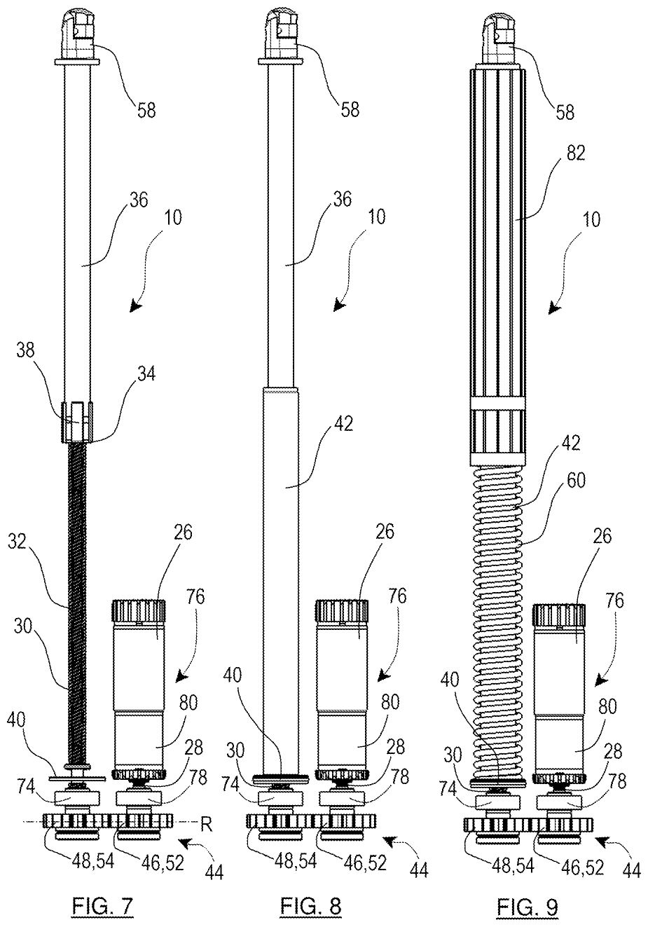

In the examples of FIGS. 1-4 and of FIGS. 6-9, the motor wheel 46 is a motor gear 52 and the spindle wheel 48 is a spindle gear 54. The motor gear 52 and the spindle gear 54 have toothed profiles that directly mesh with each other. Alternatively, the force transmission may be carried out by a drive belt 56 as shown in FIG. 5 so that the motor wheel 46 and the spindle wheel 48 are not in direct contact with each other and instead are coupled via the drive belt 56. All examples of the present disclosure have in common that the motor wheel 46 and the spindle wheel 48 extend in a common plane R of rotation, thereby reducing axial space requirements.

In the example of FIGS. 1-4, the toothed profiles of the motor gear 52 and the spindle gear 54 are helical gears to enhance to force transmission. Alternatively, in the example of FIGS. 6-9, the motor gear 52 and the spindle gear 54 are spur gears. Either profile, helical or straight, may implement a motor gear 52 and a spindle gear 54 of equal size as shown in the example of FIGS. 6-9. The sizes of the motor gear 52 and the spindle gear 54 may be chosen to implement another speed reduction to enhance the force transmission by selecting a motor gear 52 of a smaller diameter than the spindle gear 54 as illustrated in the example of FIGS. 1-4. The same size consideration applies to the motor wheel 46 and the spindle wheel 48 of a belt driven transmission as shown in FIG. 5.

The nut tube 36 has a free end extending outward from the strut housing 12 beyond the drive spindle 30 and has an end plug 58 shaped as a movable attachment element for attachment to a movable vehicle part. In particular in examples, in which the motor wheel 46 and the spindle wheel 48 are of the same size as shown in FIGS. 6-9, a compression spring 60 may be used to enhance the driving force to extend the power strut assembly 10. The compression spring 60 surrounds the nut tube 36 and axially biases the nut tube 36 in a direction away from the spindle wheel 48. The compression spring 60 is supported at one end on the anti-rotation disc 40, and at the other end on a collar of the end plug 58. The compression spring may be used regardless of the relative diameters of the motor wheel 46 and the spindle wheel 48, but the compression spring 60 may be unnecessary in examples where the driving force applied by the motor is sufficient by itself.

As shown in FIGS. 1, 2, and 6, the first end cap 16 has an axial protrusion 62 shaped as a stationary attachment element for attaching the strut housing 12 to a stationary vehicle part. The power strut assembly 10 operates to change the distance between the protrusion 62 and end plug 58 on the nut tube 36. The first end cap 16 is common to all examples shown.

The second end cap 18 in not present in all examples. It is shown in the first example having a spindle tube 22 as part of the strut housing 12. The second end cap 18 has a cable opening 64, through which a cable bundle 66 extends. The cable bundle 66 is connected to the drive motor 26 and terminates in an electric connector 68 outside of the strut housing 12. The cable opening 64 is fitted with a flexible gasket 70 guiding and protecting the cable bundle 66. The second end cap 18 has a tube opening 72, through which the nut tube 36 extends out of the strut housing 12.

In contrast, the second end cap 18 is not required in arrangements that feature a compression spring 60 as shown in the third example of FIGS. 6 through 9. The compression spring 60 further makes a stationary outer tube 42 unnecessary. Instead, the example of FIGS. 6-9 includes a slide tube 82 that moves with the nut tube 36 and that has a diameter greater than the compression spring 60 to slide over the compression spring 60 in a retracted state of the power strut assembly 10.

A spindle bearing 74 coaxial with the spindle rotary axis S is mounted in the strut housing 12 and supports the drive spindle 30 between the threaded section 32 and the spindle wheel 48. The outer circumference of the spindle bearing 74 is press-fitted into the strut housing 12 that extends around the spindle bearing 74 or is otherwise affixed.

The drive motor 26 is contained in a motor housing 76 fixedly held in the strut housing 12. The motor housing 76 includes not only the electric drive motor 26, but also a speed reduction gear assembly 80 for increasing the torque of the output shaft 28. A suitable compact reduction gear assembly designed as a two-stage planetary gear box is, for example, disclosed in U.S. Pat. No. 9,822,843, with coaxial input and output axes. The output shaft 28 of the drive motor 26 is supported by a motor bearing 78 arranged between the motor housing 76 and the motor wheel 46. The outer circumference of the motor bearing 78 is press-fitted into the strut housing 12 or otherwise affixed.

Various features of the three described examples are interchangeable, and the present invention is not limited to any feature combinations within individual examples. Accordingly, for example, the slide tube 82 and the compression spring 60 may still be accommodated inside a spindle tube 22 of the strut housing 12, the drive belt 56 may be used with a motor wheel 46 and a drive wheel of equal size with or without a compression spring 60, spur gears or helical gears may be used for equally sized or differently sized motor gear 52 and spindle gear 54, with or without a compression spring 60. Accordingly, the various options have been discussed by topic and not in the order of the individual examples shown in the drawings.

While the above description constitutes the preferred embodiments of the present invention, the invention is susceptible to modification, variation and change without departing from the proper scope and fair meaning of the accompanying claims.

What is claimed is:

1. A power strut assembly for raising and lowering a panel of an automotive vehicle, comprising:
a strut housing defining two parallel axes, one of which is a motor rotary axis and the other one of which is a spindle rotary axis;
a drive motor disposed in the strut housing, the drive motor having an output shaft rotatable by the drive motor about the motor rotary axis;
a drive spindle with a threaded section at least partially disposed in the strut housing, the drive spindle being rotatable about the spindle rotary axis parallel to the motor rotary axis;
a spindle nut arranged on the threaded section of the drive spindle;
a motor-spindle transmission for transmitting a rotation of the output shaft to the drive spindle, the motor-spindle transmission including:
a motor wheel secured to the output shaft and configured to be rotated by the drive motor about the motor rotary axis; and
a spindle wheel rigidly coupled to the drive spindle and configured to rotate about the spindle rotary axis;
wherein the motor wheel and the spindle wheel extend in a common plane of rotation.

2. The power strut assembly of claim 1, wherein the motor wheel is a motor gear and the spindle wheel is a spindle gear and wherein the motor gear and the spindle gear have toothed profiles that mesh with each other.

3. The power strut assembly of claim 2, wherein the motor gear and the spindle gear are spur gears.

4. The power strut assembly of claim 2, wherein the toothed profiles of the motor gear and the spindle gear are helical gears.

5. The power strut assembly of claim 1, wherein the motor wheel and the spindle wheel are coupled via a drive belt.

6. The power strut assembly of claim 1, further comprising a nut tube affixed to the spindle nut, the nut tube having a free end extending outward from the strut housing beyond the drive spindle and having an end plug shaped as a movable attachment element for attachment to a movable vehicle part.

7. The power strut assembly of claim 1, further comprising a compression spring surrounding the nut tube, the compression spring axially biasing the nut tube in a direction away from the spindle gear.

8. The power strut assembly of claim 1, wherein the motor wheel and the spindle wheel have identical diameters.

9. The power strut assembly of claim 1, wherein the motor wheel has a smaller diameter than the spindle wheel.

10. The power strut assembly of claim 1, wherein the strut housing has a first end cap defining a transmission space accommodating the motor wheel and the spindle wheel.

11. The power strut assembly of claim 10, wherein the first end cap has an axial protrusion shaped as a stationary attachment element for attachment to a stationary vehicle part.

12. The power strut assembly of claim 10, wherein the strut housing has a second end cap with a cable opening, through which a cable bundle connected to the drive motor extends out of the strut housing.

13. the power strut assembly of claim 12, wherein the cable opening is fitted with a flexible gasket guiding the cable bundle.

14. The power strut assembly of claim 10, wherein the second end cap has a further opening, through which a nut tube affixed to the spindle nut extends out of the strut housing.

15. The power strut assembly of claim 1, wherein the strut housing forms a motor tube and a spindle tube.

16. The power strut assembly of claim 15, wherein the strut housing further comprises stiffening ribs extending between the motor tube and the spindle tube.

17. The power strut assembly of claim 1 wherein a motor bearing coaxial with the motor rotary axis is mounted in the strut housing between the drive motor and the motor wheel.

18. The power strut assembly of claim 1, wherein a spindle bearing coaxial with the spindle rotary axis is mounted in the strut housing between the threaded section of the drive spindle and the spindle wheel.

19. The power strut assembly of claim 1, wherein the drive motor is contained in a motor housing fixedly held in the strut housing, wherein the motor housing further holds a reduction gear arrangement.
